(19) United States
(12) Patent Application Publication
(10) Pub. No.: US 2024/0344879 A1
(43) Pub. Date: Oct. 17, 2024

(54) RF FEFLECTOMETER ULTRASONIC IMPEDANCE AND TIME-OF-FLIGHT SENSOR

(71) Applicant: GEEGAH LLC, Ithaca, NY (US)

(72) Inventors: Amit Lal, Ithaca, NY (US); Jusin Kuo, Ithaca, NY (US)

(73) Assignee: GEEGAH LLC, Ithaca, NY (US)

(21) Appl. No.: 18/294,620

(22) PCT Filed: Feb. 25, 2021
(86) PCT No.: PCT/US21/19740

§ 371 Date: Feb. 2, 2024

Related U.S. Application Data
(60) Provisional application No. 62/981,513, filed on Feb. 25, 2020.

(51) Int. Cl. G01H 11/08; B06B 1/06; G01H 15/00

(52) U.S. Cl. CPC G01H 11/08; B06B 1/0688; G01H 15/00

(57) ABSTRACT

A system and/or method for RF interrogation to read surface properties such as ultrasonic impedance and temperature in the field of measuring signals at a distance. The system includes a substrate with one or more piezoelectric transducers, at least one antenna connected to the substrate or formed onto the substrate, and one or more antenna terminals extending from the antenna and connected to terminals of at least one piezoelectric transducer. The antenna receives a radio frequency pulse and actuates at least one piezoelectric transducer. The piezoelectric transducer generates an ultrasonic pulse that reflects off a back side of the substrate. The reflected ultrasonic pulse is received at the piezoelectric transducer and drives the antenna that initially received the radio frequency pulse.

### CROSS-REFERENCE TO RELATED APPLICATION

The present application claims priority to and the benefit of U.S. Provisional Patent Application No. 62/981,513, filed on Feb. 25, 2020 and entitled “RF Reflectometer Ultrasonic Impedance and Time-Of-Flight Sensor,” the entirety of which is incorporated herein by reference.

### GOVERNMENT FUNDING

This invention was made with government support under Award No. 1746710 awarded by the National Science Foundation (NSF), and the Award No. AR0001049 by the Advanced Research Projects Agency-Energy. The government has certain rights in the invention.

### BACKGROUND OF THE INVENTION

### 1. Field of the Invention

The present disclosure is directed generally to measuring signals at a distance and, more particularly, to RF interrogation to read surface properties of an object.

### 2. Background of the Invention

Sensing surfaces directly using RF (radio frequency) pulses incident on the sensor is important to eliminate the wiring from the sensors. For example, a RF signal generated from a smartphone to a sensor, and the sensor reflecting the signal eliminates the need for wires. A wireless readout allows the sensor to be placed in locations with significant physical barriers between the reader and the sensor. For example, a sensor can be placed inside a bottle made of plastic or glass elements that do not allow any direct wires to the device. Another example consists of placing the sensor inside a body, or inside building walls, where wires are not possible. Different solutions to implementing the wireless sensor nodes have been implemented in the past. A battery-powered sensor can have on-board batteries and power sources to communicate with the RF receiver/transmitter. However, the presence of power sources often leads to excessive sensor size. A sensor-node without a power source is passive and needs to be powered directly by the interrogating RF fields. In this RF powered sensor category, the RF signal can be transduced into a DC voltage using a voltage rectifier, and the recovered energy, stored on a capacitor, can then be used to power the sensor. A second approach is to transduce the RF signal on the chip such that it directly generates an ultrasonic pulse. The ultrasonic pulse is transmitted through the device, and is reflected from a surface, back into the antenna that received the Rf signal. The signal is then transmitted out as a RF signal, read out by the receiver. The different sensor areas can be sensitized by coatings such that the reflected ultrasonic pulse and the RF pulse transmitted out contain information regarding the quantity being sensed.

Therefore, there is a need for a system and/or method for RF interrogation to read surface properties such as ultrasonic impedance and temperature in the field of measuring signals at a distance.

Description of the Related Art Section Disclaimer: To the extent that specific patents/publications/products are discussed above in this Description of the Related Art Section or elsewhere in this disclosure, these discussions should not be taken as an admission that the discussed patents/publications/products are prior art for patent law purposes. For example, some or all of the discussed patents/publications/products may not be sufficiently early in time, may not reflect subject matter developed early enough in time and/or may not be sufficiently enabling so as to amount to prior art for patent law purposes. To the extent that specific patents/publications/products are discussed above in this Description of the Related Art Section and/or throughout the application, the descriptions/disclosures of which are all hereby incorporated by reference into this document in their respective entirety(ies).

### BRIEF SUMMARY OF THE INVENTION

The present disclosure is directed to a method and system for RF interrogation to read surface properties such as ultrasonic impedance and temperature in the field of measuring signals at a distance.

According to an aspect, the present invention is a system for RF interrogation. The system includes a substrate with one or more piezoelectric transducers, at least one antenna connected to the substrate or formed onto the substrate, and one or more antenna terminals extending from the antenna and connected to terminals of at least one piezoelectric transducer. The antenna receives a radio frequency pulse and actuates at least one piezoelectric transducer. The piezoelectric transducer generates an ultrasonic pulse that reflects off a back side of the substrate. The reflected ultrasonic pulse is received at the piezoelectric transducer and drives the antenna that initially received the radio frequency pulse.

According to an aspect, the present invention is a method for RF interrogation. The method includes the steps of: (i) providing an RF interrogation system comprising a substrate having a top surface and a back side, a plurality of piezoelectric transducers connected to the top surface of the substrate, and an antenna attached to each of the plurality of piezoelectric transducers; (ii) generating, by at least one of the plurality of piezoelectric transducers, ultrasonic pulses; (iii) reflecting the ultrasonic pulses off the bottom surface of the substrate as reflected ultrasonic pulses; (iv) receiving the reflected ultrasonic pulses at piezoelectric transducers; and (v) picking up reflected ultrasonic pulses by the antenna.

This and other aspects of the invention will be apparent from the embodiments described below.

### BRIEF DESCRIPTION OF THE SEVERAL VIEWS OF THE DRAWING(S)

The present invention will be more fully understood and appreciated by reading the following Detailed Description in conjunction with the accompanying drawings. The accompanying drawings illustrate only typical embodiments of the disclosed subject matter and are therefore not to be considered limiting of its scope, for the disclosed subject matter may admit to other equally effective embodiments. Reference is now made briefly to the accompanying drawings, in which:

FIG. 1 shows an isometric view of an antenna integrated with a CMOS chip, according to an embodiment;

FIG. 2 shows a schematic representation of an RF interrogation system operating at high frequencies, according to an embodiment;

FIG. 3 shows a schematic representation of an RF interrogation system, according to an alternative embodiment;

FIG. 4 is a schematic representation of a setup to determine transducer sizing for optimal power transfer; and

FIG. 5 is a schematic representation of the transducer simulated to determine the transient response.

### DETAILED DESCRIPTION OF THE INVENTION

Aspects of the present invention and certain features, advantages, and details thereof, are explained more fully below with reference to the non-limiting examples illustrated in the accompanying drawings. Descriptions of well-known structures are omitted so as not to unnecessarily obscure the invention in detail. It should be understood, however, that the detailed description and the specific non-limiting examples, while indicating aspects of the invention, are given by way of illustration only, and are not by way of limitation. Various substitutions, modifications, additions, and/or arrangements, within the spirit and/or scope of the underlying inventive concepts will be apparent to those skilled in the art from this disclosure.

The present disclosure describes a system and method for RF interrogation to read surface properties such as ultrasonic impedance and temperature. For example, the ultrasonic impedance can correspond to the wetness of the surface. There are existing modalities where RF pulses are interfaced to an acoustic resonator such as a SAW (Surface Acoustic Wave) device to form a passive RFID where the SAW can be used to sense a number of variables depending on the coatings or other physical boundary conditions.

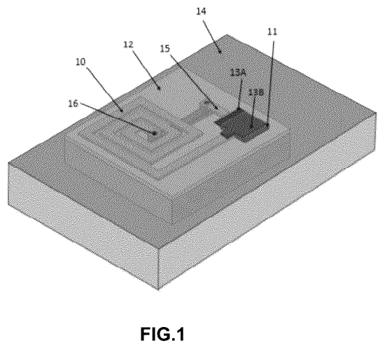

Referring now to FIG. 1, there is shown an isometric view of an antenna 10 integrated onto a substrate chip 12, which can be a CMOS (Complementary Metal Oxide Semiconductor) integrated circuit chip, according to an embodiment. The substrate chip 12 can be attached to a substrate 14. The substrate 14 can have orifices (not shown) to allow access to the back side of the chip. Alternatively, the chip 12 can be mounted such that the antenna 10 is facing downwards into the substrate 14. In the depicted embodiment, the substrate 14 is composed of flexible polymer, printed circuit board substrates, or silicon wafers; however, other materials can be used.

In the depicted embodiment of FIG. 1, the antenna 10 is composed of metal, such as copper or aluminum. In FIG. 1, the piezoelectric transducer 11 is formed of materials such as aluminum nitride or PVDF (Poly Vinyl DiFluoride). The transducer 11 is placed between two metal electrodes 13A, 13B. The traces from the antenna 10 are connected to the electrodes 13A, 13B via thin film wires 15. In order to connect the inner part of the spiral antenna 10 to the piezoelectric transducer 11, conductive vias 16 are needed to connect the two different metal layers connecting to the electrodes 13A and 13B.

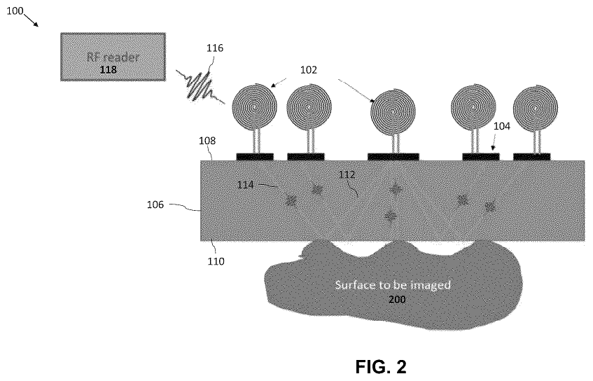

Turning now to FIG. 2, there is shown a schematic representation of an RF interrogation system 100 operating at high frequencies, according to an alternative embodiment. To create the system 100, an antenna 102 is integrated with a thin film, piezoelectric transducer 104 (also referred to as “ultrasonic transducer”). The piezoelectric transducer 104 can be an AlN transducer. The piezoelectric transducer 104 is connected to a substrate 106. The substrate 106 can be silicon or any other material suitable for the purposes described below. The piezoelectric transducer 104 is connected to a top surface 108 of the substrate 106, as shown in FIG. 2.

In another embodiment, the CMOS chip 12 and substrate 14 of FIG. 1 are integrated with the piezoelectric transducer 104. In such an embodiment, the piezoelectric transducers 104 are positioned on the CMOS chip 12 and the antenna 10 is incorporated within the CMOS chip 12 and substrate 14, as shown in FIG. 1. The antenna 10 is a coil antenna integrated parallel to the piezoelectric transducer 104. The coil antenna 10 can have portions of different inductance to achieve the resonance frequency corresponds to different standing wave resonance of the AlN piezoelectric transducer 104. The coil antenna 10 can be distributed such that ultrasonic pulses 112 (FIG. 2) add constructively at a certain point on the backside of the CMOS chip 12.

The use of thin-film piezoelectric transducers 104 that generate ultrasonic pulses into a substrate 14, 106 (and, in some cases, a CMOS chip 12) are described in detail in PCT/US20/35537 assigned to the assignee hereof and incorporated herein in its entirety by reference. The following description of the use of the piezoelectric transducers 104 applies to both the antenna 10, 102 embodiments shown in FIGS. 1 and 2.

In the embodiment of the system 100 shown in FIG. 2, a plurality of piezoelectric transducers 104 are connected to a proximalmost, top surface 108 of the substrate 106. In the depicted embodiment, the piezoelectric transducers 104 are spaced and/or placed at predetermined locations along the top surface 108. An antenna 102 is connected to each of the piezoelectric transducers 104 and are external to the substrate 106.

In use, the system 100 is placed adjacent to or on an object 200 to be imaged. Specifically, the distalmost, bottom surface 110 of the substrate 106 is placed adjacent to or on an object 200 to be imaged. The piezoelectric transducers 104 emit ultrasonic pulses 112 toward the bottom surface 110 of the substrate 106. The ultrasonic pulses 112 are reflected from the bottom surface 110 as incident RF pulses 114 (also referred to as “reflected ultrasonic pulses”), generating a voltage when received at the piezoelectric transducers 104 again.

Still referring to FIG. 2, the piezoelectric transducers 104 are arranged in array and used to scan the ultrasonic impedance of the substrate 106 touching the object 200. The transduction physics leads to generating diffraction patterns of ultrasonic pulses 114 (waves) that lead to higher order beams at different angles from the piezoelectric transducer 104. The diffracted ultrasonic pulses 114 (waves) arrive to the top of the substrate 106 at a different location on the substrate 106, as shown in FIG. 2.

The incident RF pulses 114 are received by the piezoelectric transducers 104 and are picked up by the integrated RF antenna 102 and drive the piezoelectric transducers 104. Once the ultrasonic pulse 112 comes back as the reflected ultrasonic pulses 114 after traversing the bulk substrate 106, it can radiate a signal 116 back out of the antenna 102 to be picked up on a reader 118. In the depicted embodiment, the reader 118 is a RF reader spaced from the substrate 106 but close enough to receive the signal 116.

As shown in FIG. 2, the antenna 102 can be connected to an initial piezoelectric transducer 104A or to some (or all) of the piezoelectric transducers 104 at locations that pick up the diffracted orders. If the piezoelectric transducers 104 are spaced properly, the reflected ultrasonic pulses 114 will comprise RF waves emanating at different phases such that interference of the reflected ultrasonic pulses 114, i.e., waves, is possible. The time-of-flight of the ultrasonic pulses 112, 114 can be decoded by reading the phases of the reflected ultrasonic pulses 114 and can be measured. The time-of-flight of the ultrasonic pulses 112, 114 has been shown to be proportional to the temperature of the substrate 106.

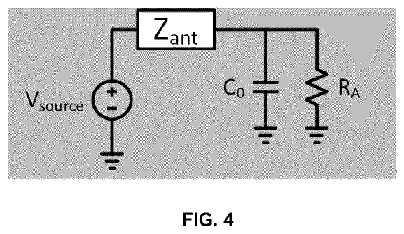

In order to verify the feasibility of this approach, an initial calculation of the reflected signal using simulations tools was conducted. A typical CMOS integrated RF antenna impedance is approximately 60+175i ohms at 2.4 GHz, as seen a paper titled “A small OCA on a 1×0.5 mm2 2.45 GHz RFID Tag-design and integration based on a CMOS-compatible manufacturing technology” by Kwong et al. The power that can be obtained from the source is 617 uW, for a perfectly matched load. It is desired to choose a transducer size that to maximize power transfer to the transducer. The circuit diagram shown in FIG. 4 can be used to represent this setup, where the voltage source V_{source} and the source impedance Zₐₙₜ are from the antenna and the clamped capacitance C₀ and the radiation resistance R_{A} are from the transducer, which is assumed to be at resonance.

For simplicity, it is assumed that the piezoelectric transducer 104 comprises an AlN thin film directly on top of a silicon substrate 106. The radiation resistance R_{A} can therefore be calculated by the following formula:

$${R}_{A} = \frac{2 {k}_{t}^{2}}{{π}^{2} {f}_{0} {C}_{0}} \frac{{Z}_{Piezo}}{{Z}_{B} + {Z}_{T}}$$

where kₜ is the piezoelectric coupling factor, f₀ is the resonance frequency of the transducer, C₀ is the clamped capacitance of the transducer, Z_{piezo} is the acoustic impedance of the piezoelectric layer, Z_{B} is the acoustic impedance of the backing layer (assumed to be air) and Z_{T} is the acoustic impedance of the transmission medium (assumed to be silicon).

For a 2.4 GHz resonance, for the particular set of film parameters we use resulted in a 2.7 um AlN thin film. Maximum power transfer is achieved for piezoelectric transducer 104 dimensions approximately 100 um×100 um.

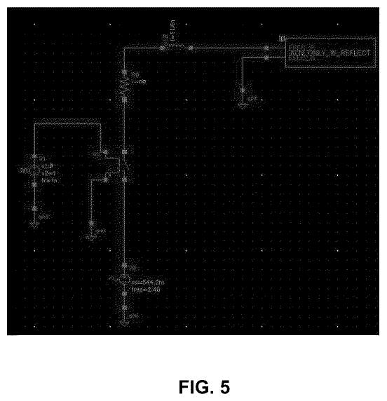

Using the Redwood model to model the piezoelectric transducer 104, the schematic in FIG. 5 was simulated in Cadence to determine the transient response—to measure the received voltage of the piezoelectric transducer 104 across the real part of the impedance of the antenna 102. The impedance of the antenna 102 at 2.4 GHz is represented by a series resistor and series inductor. An additional “gain” of 0.8 is applied to the transducer response to account for expected diffraction loss.

It can be seen that for the maximum power that can be obtained from the antenna 102, the received voltage across the antenna 102, resistance can reach ˜0.5 Vpp at 2.4 GHz for the first acoustic echo. While this initial result shows that a large acoustic signal can be obtained on chip from a pulse 116 transmitted from an integrated antenna 102, more modeling can be done to determine what the receive voltage on a receive antenna 102 will be.

The system 100, i.e., the antenna 24, 102 integrated on a CMOS chip 10 and non-CMOS substrate 106, enables an ultra-miniature device (e.g., less than or equal to 200 um×200 um×500 um). The size and cost of the system 100 can be so low that they, looking like grains of sand, can be dispersed in the soil to measure soil moisture by RF interrogation from the air. The system 100 is small enough that the systems 100 can be embedded in the surfaces by adhesive attachment. A particular use of the system 100 can be within an adhesive bandage (e.g., Band-Aid®) and enable the measurement of dry or fluidic condition of the wound. The tiny systems 100 can be embedded inside objects such as wood or metal to measure the stress or temperature inside the structure. The system 100 may also have a sensitization coating, such as a hygroscopic film, on a top surface or bottom surface of the CMOS chip 12 to detect moisture.

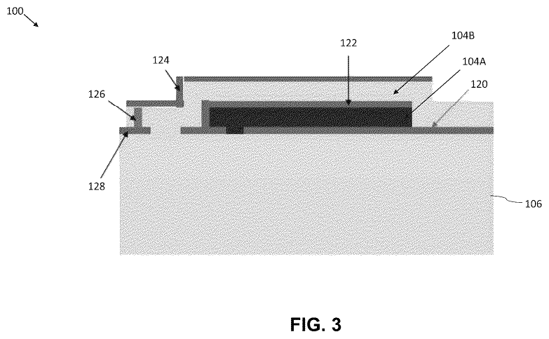

Turning now briefly to FIG. 3, there is shown a schematic representation of the RF interrogation system 100, according to an alternative embodiment. In the alternative embodiment, the system 100 has a first piezoelectric layer 104A and a second piezoelectric layer 104B connected to a proximal most, top surface 108 of the substrate 106. The substrate 106 can include a CMOS chip 12 or it can be a non-CMOS substrate, such as silicon. As shown in FIG. 3, each of the piezoelectric layers 104A, 104B contacts the substrate 106. This is possible because the second piezoelectric layer 104B (proximal-most layer) extends around the first piezoelectric layer 104A to the substrate 106.

Still referring to FIG. 3, the piezoelectric layers 104A, 104B are surrounded or sandwiched by electrodes. As shown, there is a bottom electrode 120 that is between the first piezoelectric layer 104A and the top surface 108 of the substrate 106. A common drive electrode 122 is between the first and second piezoelectric layers 104A, 104B. A top electrode 124 is the proximal-most part of the system 100 in FIG. 3 and is positioned on top of the second piezoelectric layer 104B. A via 126 connects the top electrode 124 with a connector electrode 128, which connects to a spiral inductor (not shown).

In previous implementations of GHz ultrasonic transducers 104, one piezoelectric film 104A is placed on top of a substrate 106 to launch ultrasonic waves 112 (pulses) into the substrate 106. The substrate 106 can be a CMOS wafer (e.g., CMOS chip 12) or other commonly used planar substrates such as a silicon wafer, or potentially flexible substrates. In the embodiment of the system 100 shown in FIG. 3, a second piezoelectric film 104B is added that shares one electrode (i.e., common drive electrode 122) with the bottom, first piezoelectric layer 104A. This enables the two piezoelectric transducers 104A, 104B formed to operate in parallel using the common drive electrode 122. The electrodes 120, 128 at the bottom can be used to implement the inductor (not shown) to receive RF energy that can now excite both piezoelectric 104A, 104B together. Due to the thickness of the piezoelectric devices 104A, 104B, and as the speed of sounds determines the frequencies of maximum coupling, the RF pulses from the transmitter can excite one or both piezoelectric transducers 104A, 104B.

In one implementation, the top, second piezoelectric layer 104B can be a soft polymer PVDF material. Because the speed of sound in PVDF is low (˜2200 m/s), and it can be made into thicker films. For example, there are numerous examples of PVDF transducers with 10-1000 micrometer thickness, and one can achieve 10-500 MHz thickness mode resonance transducers. However, since PVDF is a polymer, it has higher internal mechanical losses at higher frequencies, and hence is more appropriate for lower frequency ultrasonic transducers. Hence, the waves launched into the substrate 106 or the medium above the top, second piezoelectric layer 104B can now be at two different resonance frequencies. The PVDF can launch waves in the 10-200 MHz range, while the bottom piezoelectric film can be the AlN thin film transduce, and it can launch waves in the 500 MHz to several GHz range. This broad range of resonance frequency has the advantage that the lower frequency ultrasonic waves can penetrate deeper into a medium on the top or bottom of the chip and/or non-CMOS substrate. The lower frequency leads to deeper penetration of waves, at reduced lateral resolution. The ability to image and sense volumes both deeper into a material at lower spatial resolution, and sense volumes that are smaller near the interface, but at high special resolution can enable a more complete interrogation with the RF transduced pulses. The transducers formed by the two piezoelectric layers can also be actively driven with integrated CMOS transistors or external electronics to excite both transducers at simultaneously. The sharing of the common electrode is important to minimize the need for further processing to create electrodes for both piezoelectric layers.

While various embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

The above-described embodiments of the described subject matter can be implemented in any of numerous ways. For example, some embodiments may be implemented using hardware, software or a combination thereof. When any aspect of an embodiment is implemented at least in part in software, the software code can be executed on any suitable processor or collection of processors, whether provided in a single device or computer or distributed among multiple devices/computers.

What is claimed is:

1. A RF interrogation system, comprising:
a substrate with one or more piezoelectric transducers;
at least one antenna connected to the substrate or formed onto the substrate;
one or more antenna terminals extending from the antenna and connected to terminals of at least one piezoelectric transducer;
wherein the antenna receives a radio frequency pulse and actuates at least one piezoelectric transducer;
the piezoelectric transducer generates an ultrasonic pulse that reflects off a back side of the substrate;
further wherein the reflected ultrasonic pulse is received at the piezoelectric transducer and drives the antenna that initially received the radio frequency pulse.

2. The system of claim 1, wherein the substrate is a CMOS chip with the piezoelectric transducers, patterned thin metal film inductors, and transistor electronics to process data and harvest RF energy integrated therewith.

3. The system of claim 2, where the thin metal film inductors are formed by connecting metal layers available in the CMOS chip.

4. The system of claim 1, wherein the antenna is fabricated on a separate substrate and electrically connected to the piezoelectric transducers on the substrate.

5. The system of claim 1, wherein the antenna is a coil antenna connected to at least one piezoelectric transducer.

6. The system of claim 5, wherein the coil antenna has portions of different inductances.

7. The system of claim 1, wherein the substrate is a flexible polymer.

8. The system of claim 1, wherein the substrate is a silicon substrate.

9. The system of claim 1, wherein the size of the system is less than 500 um×500 um×500 um.

10. The system of claim 1, further comprising a sensitive coating on the substrate surfaces.

11. The system of claim 10, wherein the sensitive coating is a hygroscopic material.

12. The system of claim 1, wherein the antenna transmits the reflected ultrasonic pulse as a RF signal.

13. The system of claim 12, further comprising a RF reader spaced from the antenna, the RF reader configured to receive the RF signal from the antenna.

14. The system of claim 13, wherein the RF reader conducts correlation matching to extract at least one of amplitude and the time-of-flight of the ultrasonic pulse through the substrate.

15. The system of claim 1, further comprising an object to be imaged contacting the bottom surface of the substrate.

16. The system of claim 1, wherein the reflected ultrasonic pulses comprise RF waves emanating at different phases.

17. The system of claim 1, the ultrasonic pulses are generated from two or more piezoelectric transducers to generate a focused ultrasonic pulse.

18. The system of claim 1, wherein the piezoelectric transducer is formed with two stacked piezoelectric layers sharing a common electrode to form two transducers in parallel.

19. The system of claim 18, wherein the two stacked piezoelectric layers are connected to an inductor.

20. The system of claim 19, wherein the two stacked piezoelectric layers comprise a bottom transducer layer composed of a thin film AlN (aluminum nitride) piezoelectric based transducer, and a top transducer layer based on PVDF piezoelectric transducer.

21. The system of claim 19, wherein the two stacked piezoelectric layers comprise a bottom transducer layer composed of a thin film AlScN (aluminum scandium nitride) piezoelectric based transducer, and a top transducer layer based on PVDF piezoelectric transducer.

22. A method for RF interrogation, comprising the steps of:
providing an RF interrogation system comprising a substrate having a top surface and a back side, a plurality of piezoelectric transducers connected to the top surface of the substrate, and an antenna attached to each of the plurality of piezoelectric transducers;
generating, by at least one of the plurality of piezoelectric transducers, ultrasonic pulses;
reflecting the ultrasonic pulses off the back side of the substrate as reflected ultrasonic pulses;
receiving the reflected ultrasonic pulses at piezoelectric transducers; and
picking up reflected ultrasonic pulses by the antenna.

23. The method of claim 22, further comprising the step of transmitting the reflected ultrasonic pulse as a RF signal.

24. The method of claim 23, further comprising the step of receiving the RF signal at a RF signal reader.
